(19) United States
(12) Patent Application Publication
(10) Pub. No.: US 2025/0121345 A1
(43) Pub. Date: Apr. 17, 2025

(54) DEFORMABLE COMPLEMENTARY MOISTURE AND TRIBO ENERGY HARVESTER

(71) Applicant: UIF (University Industry Foundation ), Yonsei University, Seoul (KR)

(72) Inventors: Cheol Min PARK, Seoul (KR); Gwan Ho KIM, Seoul (KR)

(73) Assignee: UIF (University Industry Foundation ), Yonsei University, Seoul (KR)

(21) Appl. No.: 18/908,839

(22) Filed: Oct. 8, 2024

(30) Foreign Application Priority Data
Oct. 11, 2023 (KR) 10-2023-0135341
May 24, 2024 (KR) 10-2024-0067622

(51) Int. Cl. B01J 13/00

(52) U.S. Cl. CPC B01J 13/0065

(57) ABSTRACT

According to one embodiment, an organo-ionic hydrogel foam, includes: a MXene foam comprising MXene and having a three-dimensional framework structure; and an organo-ionic hydrogel coating a portion of the MXene foam. A dry-state region not coated by the organo-ionic hydrogel is positioned over a wet-state region coated by the organo-ionic hydrogel.

### CROSS-REFERENCE TO PRIOR APPLICATION

This Application claims priority to Korean Patent Application Nos. 10-2023-0135341 (filed on Oct. 11, 2023) and 10-2024-0067622 (filed on May 24, 2024), which are hereby incorporated by reference in their entirety.

### BACKGROUND

The present invention relates to moisture-induced electric generators (MEGs) and triboelectric nanogenerators (TENGs), more specifically to a deformable complementary moisture and tribo energy harvester using a MXene/organo-ionic hydrogel foam (MOHF).

Energy harvesting using moisture-induced electric generators (MEGs) is of great interest because water is ubiquitous, covering two-thirds of the Earth's surface, and approximately 10% of freshwater exists in the atmosphere in the form of clouds and fog. These blue energy harvesters convert chemical energy into electrical energy by utilizing the gradient in the ion concentration, which arises when free charged ions are released upon the spontaneous adsorption of water molecules on hygroscopic functional groups (such as —OH, —COOH, etc.) within an asymmetric moisturizing regulation or chemical-gradient structure. Several studies have attempted to realize high-performance MEGs using various materials such as surface-modified carbon, graphene oxide, cellulose-based materials, protein-based biomaterials, polymers, metal-organic frameworks, and metal oxides. Nevertheless, the current densities of the device units have been unsatisfactory and some devices require water immersion, which makes them unsuitable for application in portable and wearable electronics.

Recently, significant advancements have been witnessed in the development of MEGs with ionic hydrogels that possess exceptional water-capturing and fast ion-transport capabilities through their three-dimensional (3D) porous structure. The MEGs with ionic hydrogels efficiently overcome the issue of insufficient total ions in ionized water, thereby enhancing the output currents of the devices. Furthermore, owing to their distinctive interactions with water molecules, ionic hydrogels can be employed as water reservoirs that continuously supply hydrated ions over an extended period. On the other hand, to further improve the harvesting performance, MEGs can be effectively integrated with other energy harvesters. For instance, a high-performance MEG system was developed by incorporating a photosensitive phytochrome into a hydrophilic polyelectrolyte. However, although such a hybrid MEG system successfully harvested energy from both moisture and sunlight synchronously, the power still needs to be improved, requiring the arrays of the hybrid MEGs for improvement of power due to their output voltage typically in the range of hundreds of millivolts to approximately 1.0 V. Hence, we, the inventors of the present invention, envisioned that harvesters based on mechanical-energy conversions such as piezo- and triboelectricity could be good candidates for high-performance hybrid MEGs because of their capability for readily generating high output voltages. An MEG with a unique ion-selective surface could also be suitable for triboelectrification, particularly, involving repetitive mechanical contact electrification, giving rise to a high-power hybrid MEG with a triboelectric nanogenerator (TENG). However, to develop such a hybrid MEG, several issues should be resolved. First, energy harvesting at the high humidities often required for MEG operation should be avoided because of a substantial decrease in the power efficiency of the TENG at high humidities. More importantly, the mechanical resilience and robustness of the hybrid MEG should be guaranteed, making the device tolerant to harsh deformation and repetitive contact.

### Prior Art Documents

### Patent Documents

(Patent Document 1) Korean Patent No. 10-2543736 (Publication Date: Jun. 14, 2023)

### SUMMARY

One objective of the present invention is to provide a device that can solve the problem that it is difficult to fuse with a tribo-based energy generator due to the low mechanical properties of the devices used in conventional moisture-induced electric generation, making it difficult to further amplify energy.

Also, one objective of the present invention is to provide more practical applications by utilizing both direct and alternating current systems simultaneously, as opposed to simply driving commercially available electronic devices with moisture-induced electric generation.

According to one aspect of the present invention, provided is an organo-ionic hydrogel foam, comprising: a MXene foam comprising MXene and having a three-dimensional framework structure; and an organo-ionic hydrogel coating a portion of the MXene foam, wherein a dry-state region not coated by the organo-ionic hydrogel is positioned over a wet-state region coated by the organo-ionic hydrogel.

According to another aspect of the present invention, a method of manufacturing an organo-ionic hydrogel foam is provided, the method comprising: preparing a MXene foam comprising MXene and having a three-dimensional framework structure; and coating a portion of the MXene foam with an organo-ionic hydrogel.

According to another aspect of the present invention, provided is a moisture-induced electric generator, comprising: the organo-ionic hydrogel foam; a first conductive substrate disposed on a lower portion of the organo-ionic hydrogel foam; and a second conductive substrate inserted into the dry-state region of the organo-ionic hydrogel foam.

According to another aspect of the present invention, provided is a triboelectric generator, comprising: the organo-ionic hydrogel foam; a third conductive substrate disposed on a upper portion of the organo-ionic hydrogel foam; and a fourth conductive substrate inserted into the dry-state region of the organo-ionic hydrogel foam.

According to another aspect of the present invention, provided is a moisture-induced electric and triboelectric generator, comprising: the organo-ionic hydrogel foam; a fifth conductive substrate disposed on a lower portion of the organo-ionic hydrogel foam; a sixth conductive substrate disposed on a upper portion of the organo-ionic hydrogel foam; and a seventh conductive substrate inserted into the dry-state region of the organo-ionic hydrogel foam, wherein, the fifth conductive substrate, the organo-ionic hydrogel foam, and the seventh conductive substrate generate direct current (DC) power by moisture-induced electric generation, and wherein, the sixth conductive substrate, the organo-ionic hydrogel foam, and the seventh conductive substrate generate alternating current (AC) power by triboelectric generation.

According to another aspect of the present invention, provided is an emergency-exit guidance system using the moisture-induced electric and triboelectric generator, wherein the direct current (DC) power by moisture-induced electric generation is always on, and wherein the alternating current (AC) power by triboelectric generation is generated by the steps of individuals evacuating in emergency situations.

According to one embodiment of the present invention, an energy generator capable of generating complementarily high power through high current moisture-induced electric generation and high voltage triboelectric generation in one device can be made.

Furthermore, according to one embodiment of the present invention, an energy generator capable of generating direct current and alternating current simultaneously can be substantially utilized and applied as a self-powered system for emergency evacuation lights, etc.

### BRIEF DESCRIPTION OF THE DRAWINGS

FIGS. 1a-1i show characterization of fabricated MXene/organo-ionic hydrogel foam (MOHF) prepared according to one embodiment of the present invention.

FIGS. 2a-2h show electrical performance of the MEG-MOHF prepared according to one embodiment of the present invention.

FIGS. 3a-3h show working mechanism of the MEG-MOHF prepared according to one embodiment of the present invention.

FIGS. 4a-4g show mechanical characteristics of the MEG-MOHF prepared according to one embodiment of the present invention.

FIGS. 5a-5j show electrical performance of an TENG-MOHF prepared according to one embodiment of the present invention.

FIGS. 6a-6h show electrical performance of a complementary MEG-TENG-MOHF prepared according to one embodiment of the present invention.

FIGS. 7a-7d show how to prepare and utilize an emergency exit guidance system according to one embodiment of the present invention.

### DETAILED DESCRIPTION

The above objects, other objects, characteristics, and advantages will be easily understood through the following preferred embodiments related to the accompanying drawings. However, the present invention is not limited to the embodiments described herein, and may be implemented in various different forms. Rather, the embodiments introduced herein are provided to make the disclosed content thorough and complete, and sufficiently convey the technical spirit to those skilled in the art.

In the description of each drawing, like reference numerals are used for like constituent elements. In the accompanying drawings, the dimensions of the structures are illustrated while being enlarged compared with actual dimensions for clarity of the present invention. Terms such as first and second may be used to describe various constituent elements, but the constituent elements are not limited by the terms. The terms are used only to distinguish one constituent element from another constituent element. For example, without departing from the scope of the invention, a first constituent element may be called a second constituent element, and similarly, the second constituent element may be called the first constituent element. Singular expressions include plural expressions unless the context clearly indicates otherwise.

In the present specification, it will be appreciated that the term “include” or “have” is intended to designate the presence of characteristics, numbers, steps, operations, constituent elements, and parts described in the specification or combinations thereof, and does not exclude in advance the possibility of the presence or addition of one or more other characteristics, numbers, steps, operations, constituent elements, and components, or combinations thereof. Furthermore, a case where a part such as a layer, a film, a region, and a plate is present “on” another part includes not only a case where the part is present “directly on” another part, but also a case where still another part is present therebetween. Conversely, a case where a part such as a layer, a film, a region, and a plate is present “under” another part includes not only a case where the part is present “directly below” another part, but also a case where still another part is present therebetween.

Unless otherwise specifically described, all numbers, values, and/or expressions for expressing quantities of ingredients, reaction conditions, polymer compositions, and mixtures, which are used in the specification, are to be understood as modified in all instances by the term “about” because these numbers are essentially approximations that are reflective of, among other things, various uncertainties of measurement encountered in obtaining such values. In addition, when a numerical range is disclosed in the present description, the numerical range is continuous, and includes, unless otherwise indicated, every value from a minimum value to a maximum value of the numerical range. Furthermore, when the numerical range refers to integers, unless otherwise indicated, the integers include every integer from a minimum value to a maximum value of the numerical range.

Herein, we present a deformable complementary moisture and triboelectric energy harvester with positive-ion-selective two-dimensional (2D) MXene (Ti₃C₂Tₓ) flakes deposited on a resilient 3D melamine foam. To ensure high performance of the MEG at low humidities, one fifth of the MXene foam is coated with an organo-ionic hydrogel that continuously supplies water and salt ions to the upper uncoated MXene surface. The hybrid harvester exhibits its MEG performance under various mechanical deformations with a maximum output open-circuit voltage (V_{oc}), short-circuit current density (J_{sc}), and power density of approximately 310 mV, 877 μA cm⁻², and 9.15 μW cm⁻², respectively. Our resilient MXene/organo-ionic hydrogel foam is sufficiently tolerant to more than 30,000 repetitive triboelectric contacts, leading to reliable TENG performance with an alternating current (AC) voltage of approximately 80 V. Complementary energy harvesting is achieved in our single MXene/organo-ionic hydrogel foam (MOHF) device, resulting in a maximum voltage and current of 55 V and 102 μA, respectively, and a high electric power density of approximately 83 μW cm⁻² with excellent stretchability and compression strength of approximately 30% and 2.1 MPa, respectively. Moreover, a novel optical emergency alarm and guidance system is demonstrated, powered by our complementary energy harvester with fast capacitor charging capability. The DC light emission of an alarming sensor powered in the MEG mode is amplified by the AC power in the TENG mode harvested from transient human walking motions in an emergency, effectively guiding people to an exit.

According to one aspect of the present invention, provided is an organo-ionic hydrogel foam, comprising: a MXene foam comprising MXene and having a three-dimensional framework structure; and an organo-ionic hydrogel coating a portion of the MXene foam, wherein a dry-state region not coated by the organo-ionic hydrogel is positioned over a wet-state region coated by the organo-ionic hydrogel.

According to an exemplary embodiment of the present invention, the MXene foam may be a three-dimensional melamine foam with two-dimensional MXene flakes attached thereto.

According to an exemplary embodiment of the present invention, the organo-ionic hydrogel may be based on polyacrylamide (PAM), containing glycerol and an ionic salt.

According to another aspect of the present invention, a method of manufacturing an organo-ionic hydrogel foam is provided, the method comprising: preparing a MXene foam comprising MXene and having a three-dimensional framework structure; and coating a portion of the MXene foam with an organo-ionic hydrogel.

According to an exemplary embodiment of the present invention, the preparing a MXene foam may comprise coating a surface of a melamine foam with MXene flakes.

According to an exemplary embodiment of the present invention, the coating a portion of the MXene foam may comprise partially coating the MXene foam with the organo-ionic hydrogel based on polyacrylamide (PAM) and containing glycerol and an ionic salt.

According to another aspect of the present invention, provided is a moisture-induced electric generator, comprising: the organo-ionic hydrogel foam; a first conductive substrate disposed on a lower portion of the organo-ionic hydrogel foam; and a second conductive substrate inserted into the dry-state region of the organo-ionic hydrogel foam.

According to another aspect of the present invention, provided is a triboelectric generator, comprising: the organo-ionic hydrogel foam; a third conductive substrate disposed on a upper portion of the organo-ionic hydrogel foam; and a fourth conductive substrate inserted into the dry-state region of the organo-ionic hydrogel foam.

According to another aspect of the present invention, provided is a moisture-induced electric and triboelectric generator, comprising: the organo-ionic hydrogel foam; a fifth conductive substrate disposed on a lower portion of the organo-ionic hydrogel foam; a sixth conductive substrate disposed on a upper portion of the organo-ionic hydrogel foam; and a seventh conductive substrate inserted into the dry-state region of the organo-ionic hydrogel foam, wherein, the fifth conductive substrate, the organo-ionic hydrogel foam, and the seventh conductive substrate generate direct current (DC) power by moisture-induced electric generation, and wherein, the sixth conductive substrate, the organo-ionic hydrogel foam, and the seventh conductive substrate generate alternating current (AC) power by triboelectric generation.

According to another aspect of the present invention, provided is an emergency-exit guidance system using the moisture-induced electric and triboelectric generator, wherein the direct current (DC) power by moisture-induced electric generation is always on, and wherein the alternating current (AC) power by triboelectric generation is generated by the steps of individuals evacuating in emergency situations.

Hereinafter, the present invention will be described in more detail with reference to the accompanying drawings for a better understanding of the present invention. However, the following embodiments are provided for the purpose of better understanding the invention, and the invention is not limited by the following embodiments.

### Embodiments

### Design and Characteristics of Complementary Harvester With MOHF

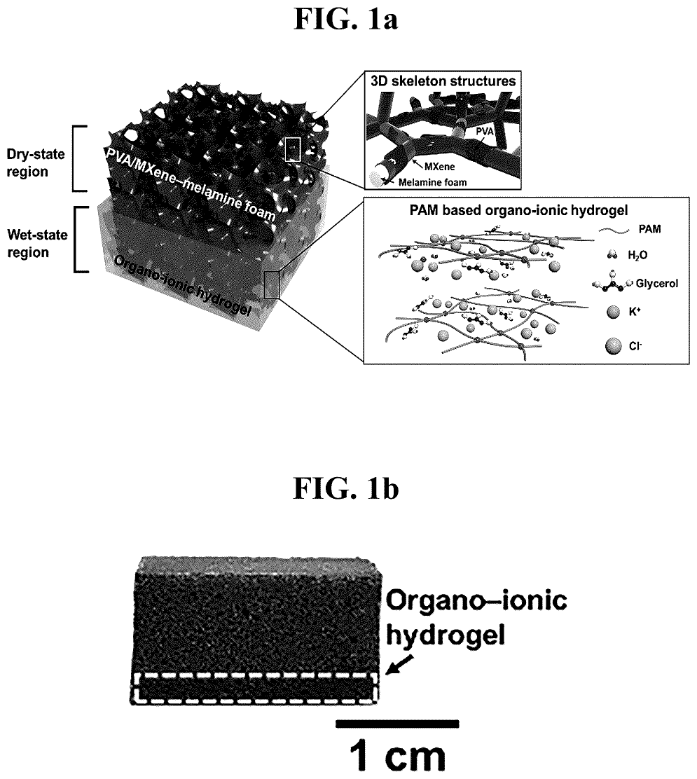

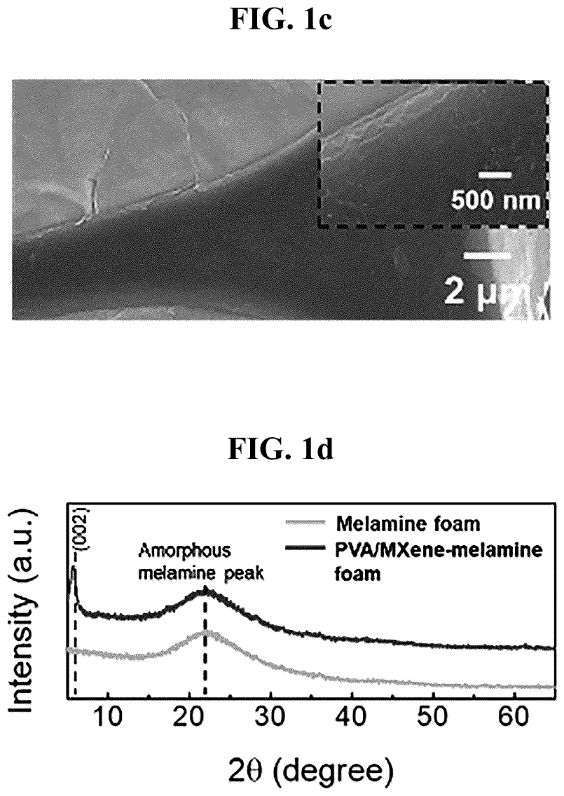

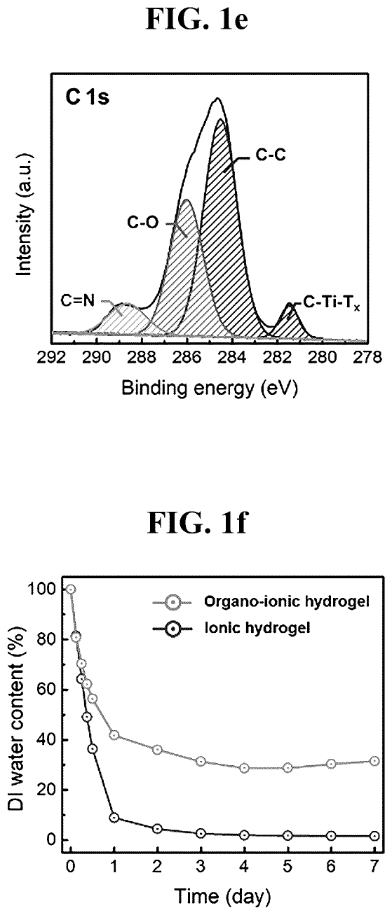

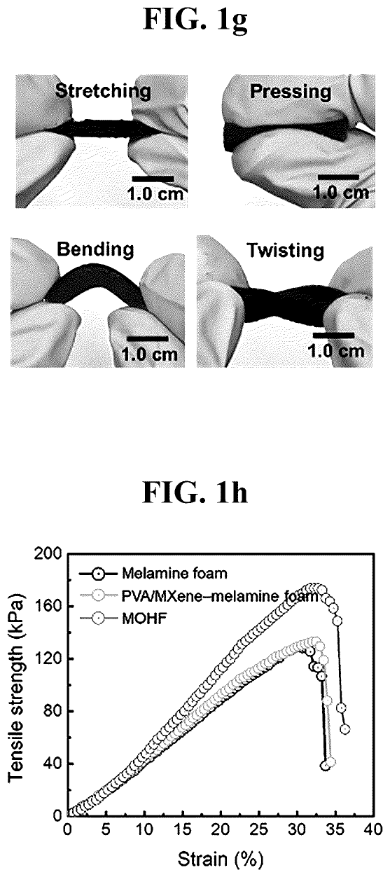

FIGS. 1a-1i show characterization of fabricated MXene/organo-ionic hydrogel foam (MOHF) prepared according to one embodiment of the present invention. Specifically, FIG. 1a is a schematic representation of the designed MOHF structure and FIG. 1b is a photograph of the MOHF. FIG. 1c is a scanning electron microscopy (SEM) images of the surface of the PVA/MXene-melamine foam structure (Inset: high-magnification SEM image). FIG. 1d is an X-ray diffraction (XRD) analysis and FIG. 1e shows C 1s X-ray photoelectron spectroscopy (XPS) spectra of the PVA/MXene-melamine foam. FIG. 1f shows Comparison of specific DI water retention abilities of the ionic and organo-ionic hydrogel under a 20% relative humidity condition over time. FIG. 1g shows Photographs of the flexible and deformable MOHF. FIG. 1h shows Strain-tensile strength curves of melamine foam, PVA/MXene-melamine foam, and MOHF. FIG. 1i shows Loading-unloading curves over 30 cycles at a maximum compressive strain of 95%.

The MOHF was fabricated through a series of dip-coating processes, followed by the partial infusion of an organo-ionic hydrogel into a dip-coated melamine foam, as shown schematically in Fig. 1a. MXene flakes were dip-coated on the surface of the melamine foam. Not only to ensure adhesion with an organo-ionic hydrogel but also to facilitate transport of both ionized water and ions from the salts dissolved in the organo-ionic hydrogel, a thin poly(vinyl alcohol) (PVA) film was subsequently coated on the MXene treated melamine foam. The organo-ionic hydrogel based on polyacrylamide (PAM), containing glycerol and an ionic salt (KCl), was partially coated on the PVA-treated MXene/melamine foam, producing an MOHF. The melamine foam was selected as a structural framework providing excellent resilience upon various mechanical deformations associated with triboelectrification. The thin MXene film coated on the melamine foam ensured high-performance moisture energy generation owing to its large specific surface area as well as high electrical conductivity. The hydrophilic PVA coated on MXene facilitated the movement of ionized water and ions, improving the MEG performance. Finally, the organo-ionic hydrogel with a unique 3D cross-linked hygroscopic polymer network served as a water and ion reservoir, continuously supplying hydration ions and salt ions to the non-coated PVA/MXene-melamine foam, as schematically shown in Fig. 1a.

The MOHF was approximately 10 mm in height, and the bottom 2 mm were coated with the organo-ionic hydrogel, as shown in the photograph in FIG. 1b. The thin MXene film coated on the melamine foam was examined with the scanning electron microscope (SEM), and the results in FIG. 1c show that the MXene flakes completely covered the melamine foam, producing the characteristic rough structure arising from the variation in the number of MXene flakes on surface (see the inset of FIG. 1c). The MXene flakes coated the melamine foam well, owing to the various terminal groups (Tₓ,=—OH, —O, —F) on the surface of MXene, which facilitated strong electrostatic interactions with the terminal amine groups on the melamine foam. The coating of MXene multilayers on the melamine foam was confirmed by the transmission electron microscopy (TEM) and energy-dispersive X-ray spectroscopy (EDS) images of a cross-section of a single PVA/MXene-melamine skeleton.

The PVA/MXene-melamine foam was further examined using high-resolution X-ray diffraction (HR-XRD) and high-resolution X-ray photoelectron spectroscopy (HR-XPS), and the results are shown in FIG. 1d and 1e, respectively. The HR-XRD results show a broad peak at 22.5°, indicating the amorphous structure of the melamine foam, and a sharp peak at 5.8° corresponding to the (002) reflection of the basal plane of Ti₃C₂. It should be noted that the amorphous characteristics of PVA are hardly recognized in the HR-XRD results, most probably because of the low concentration of PVA. The C 1s HR-XPS results in Fig. 1e display notable peaks at 281.5 eV (C—Ti—T_{X}) and 284.5 eV (C—C) associated with MXene, 286.1 eV associated with the C—O bond of PVA, and 288.7 eV corresponding to the C—N energy of melamine. The O 1s and N 1s HR-XPS results further confirm the development of thin MXene as well as PVA layers on the melamine foam.

The excellent water retention of our organo-ionic hydrogel was evaluated, and the results are presented in FIG. 1f. The weight variation of the hydrogel with time was monitored at a relative humidity (RH) of 20%. An organo-ionic hydrogel exhibited that its initial water content was rapidly decreased in a day exposure, but a constant water content was maintained even after seven days because of the strong hydrogen bonding interactions between glycerol and the adjacent water molecules. On the contrary, a conventional ionic hydrogel without glycerol exhibited a rapid decrease and reach to nearly 0% in its water content within 6 hours of exposure because of the fast evaporation of water from the ionic hydrogel (FIG. 1f). The ionic hydrogel became brittle with a substantial reduction in its dimensions, owing to the water loss, after the seven-day exposure, whereas the organo-ionic hydrogel exhibited initial mechanical flexibility. Furthermore, the organo-ionic hydrogel in our MOHF readily adhered to various materials such as plastic, glass, metal, rubber, wood, and fabric, owing to its excellent moisture retention. The MOHF was mechanically resilient and susceptible to diverse mechanical deformations such as stretching, compression, bending, and twisting, as shown in the photographs in FIG. 1g. The details of the mechanical properties of the MOHF are presented in FIG. 1h and 1i. The stress-strain curve of the MOHF in the tensile state exhibits a maximum tensile stress of 173 kPa at a strain of 32%. Because the organo-ionic hydrogel in our MOHF is strongly bonded to a PVA/MXene-melamine foam through hydrogen bonds, the tensile stress of the MOHF is higher than that of both the PVA/MXene-melamine foam and melamine foam. In the compressive tests, our MOHF exhibited a maximum stress of ˜2.1 MPa at a strain of 95%, and its excellent resilience was demonstrated with nearly identical stress-strain hysteresis loops even after 30 pressing/depressing cycles.

### MEG Performance of a MOHF

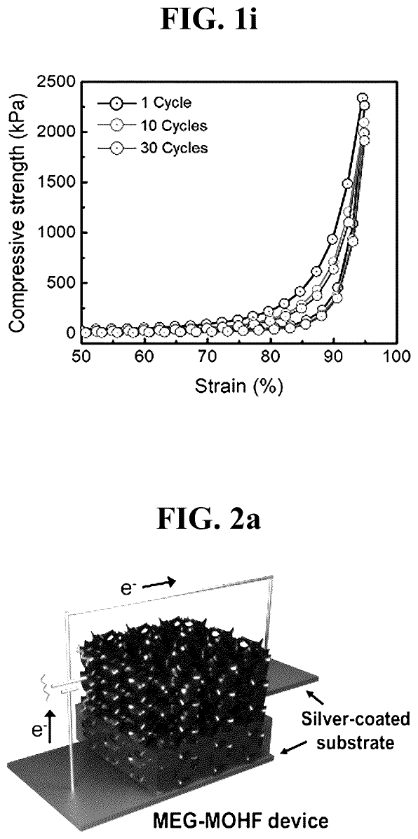

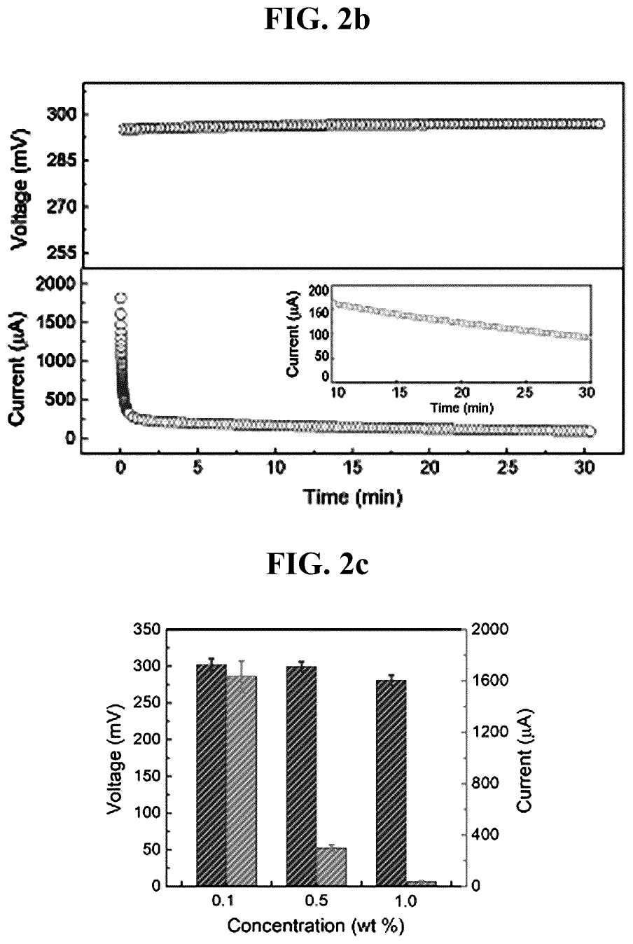

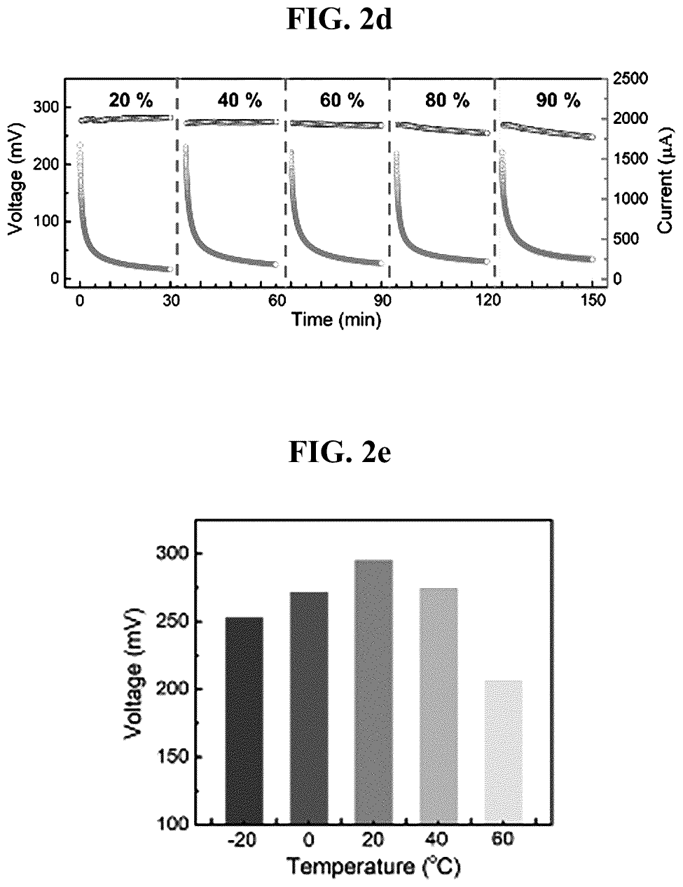

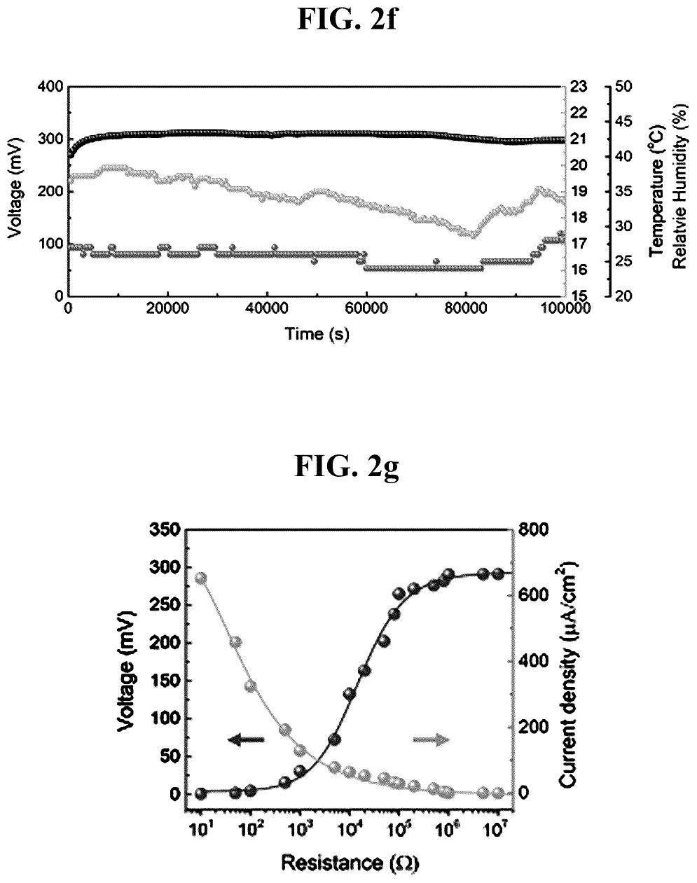

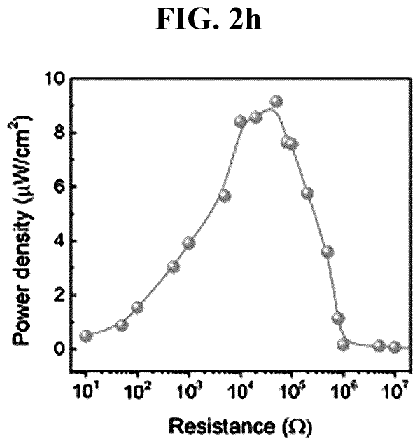

FIGS. 2a-2h show electrical performance of the MEG-MOHF prepared according to one embodiment of the present invention. Specifically, FIG. 2a shows Schematic illustrating the device architecture of the MEG-MOHF. FIG. 2b shows Open-circuit voltage (V_{oc}) and short-circuit current (I_{sc}) of the MEG-MOHF under ambient conditions (@20% RH, 21° C.). FIG. 2c shows V_{oc} and I_{sc} of the MEG-MOHF device for various concentrations of PVA. FIG. 2d shows V_{oc} and I_{sc} under various RH conditions. FIG. 2e shows Output voltage of the MEG-MOHF as a function of temperature. FIG. 2f shows Continuous V_{OC} output (black curve) from the MEG-MOHF over time in an open ambient environment, with simultaneous recordings of ambient relative humidity (blue curve) and temperature (red curve). FIG. 2g shows V_{oc} and J_{sc} of our MEG-MOHF as a function of external loads from 10 Ω to 10 MΩ at 20% RH. FIG. 2h shows Power density calculated from V_{oc} and J_{sc} measurements according to FIG. 2g.

An MEG with our MOHF (MEG-MOHF) was developed by placing the MOHF on a silver-paste-coated glass substrate and inserting a silver-paste-coated polyethylene terephthalate (PET) substrate into the middle part of the PVA/MXene-melamine foam of MOHF not covered with the organo-ionic hydrogel, as shown schematically in FIG. 2a. The electrical performance of our MEG-MOHF was evaluated, and the results are presented in FIG. 2b. Under ambient conditions with low relative humidity (RH 20%), the MEG-MOHF demonstrated a stable V_{oc} of approximately 300 mV and short-circuit current (I_{sc}) ranging from approximately 1800 to 100 μA over a 30-min period. The power generation with reliable V_{oc} and high I_{sc} was ascribed to the asymmetrical moisture absorption characteristics of the MOHF, giving rise to an excellent moisture gradient from the bottom to top of the MOHF. In contrast, MEG devices with symmetrical moisture-absorption structure, such as silver/PVA/MXene-melamine foam/silver or silver/organo-ionic hydrogel/silver rarely showed noticeable V_{oc} or I_{sc}, owing to the negligible moisture gradient.

FIG. 2c presents the electrical performance of the MEG-MOHF, according to the PVA concentration. When a low concentration (0.1 wt %) of PVA was coated on the MXene/melamine foam, the resulting MEG-MOHF produced a V_{oc} of approximately 300 mV and maximum I_{sc} of approximately 1600 μA. However, when the PVA concentration was increased to 1.0 wt %, a significant reduction in the maximum I_{sc}, to approximately 34.6 μA, was observed. This significant reduction in I_{sc} could be attributed to the electrically insulating characteristics of PVA, which hindered the charge transport from the conductive MXene to an external electrode. It should, however, be noted that PVA coating is essential because, in the absence of PVA treatment, the generated voltage gradually decreased over time because of the insufficient movement of water required to induce an ionic potential in the MOHF. An optimal PVA concentration of 0.1 wt % was thus chosen for the subsequent experiments.

To evaluate the influence of various environmental conditions, first, we measured the electrical performance of the MEG-MOHF under a wide range of RHs from 20 to 90% for 30 min, and the results are presented in FIG. 2d. At 20% RH, the MEG-MOHF after 30 min operation exhibited a V_{oc} and I_{sc} of approximately 285 mV and 124 μA, respectively. A slight decrease in V_{oc} was observed upon increasing the RH, but this decrease was marginal. On the other hand, the I_{sc} of the device after 30 min of operation increased slightly with the RH, exhibiting values of approximately 183, 198, 221, and 245 μA for 40, 60, 80, and 90%, respectively. In the initial state, a moisture and ionic gradient was developed in our MOHF from bottom to top because of the partially coated organo-ionic hydrogel in the MOHF. When the RH increased, both the moisture absorption and ion dissociation were enhanced, with many ions into regions not coated with the organo-ionic hydrogel, producing a gradual decrease in the ionic gradient. We speculate that the decrease and increase in V_{oc} and I_{sc} with RH, respectively, can be attributed to the reduction in the ionic gradient with the RH.

Second, we investigated the output V_{oc} of the MEG-MOHF across a range of temperatures from −20 to 60° C., as shown in FIG. 2e. The highest V_{oc} of approximately 300 mV was obtained at 20° C. Although water could flow to the coated PVA/MXene layer in a MOHF at temperatures below the freezing point of water, because of the excellent anti-freezing ability of the glycerol and ionic salts in the organo-ionic hydrogel, the ion mobility within the MOHF decreased. This reduced mobility led to a decrease in the ionic gradient, thereby decreasing the V_{oc}. At elevated temperatures, the enhanced ion mobility allowed the ions to readily diffuse toward the top electrode, decreasing the ionic gradient with temperature and resulting in a decrease in V_{oc}. Therefore, the balanced water-molecule absorption and ion transport at an appropriate temperature is significant for obtaining a stable electrical output from the MEG-MOHF. Our single MEG-MOHF can deliver a stable V_{oc} with a maximum value of 310 mV for over an entire day under an open ambient environment with slightly fluctuating RH (23 to 30%) and temperature (17 to 20° C.) (FIG. 2f). The stable V_{oc} of the MEG-MOHF, attributed to the long-term sustained ionic gradient within the MOHF, was further validated through COMSOL simulations. The power densities of the MEG-MOHF were obtained by measuring the V_{oc} and J_{sc} as functions of the external loads from 10 Ω to 10 MΩ, as presented in FIG. 2g. The V_{oc} significantly increased with increasing resistance whereas the output J_{sc} decreased. A maximum power density of 9.15 μW cm⁻² was obtained at 50 kΩ (FIG. 2h).

### Working Principle of MEG-MOHF

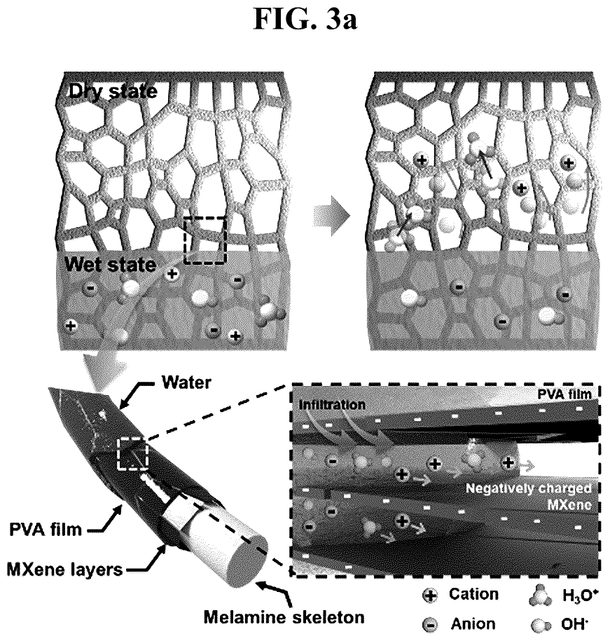

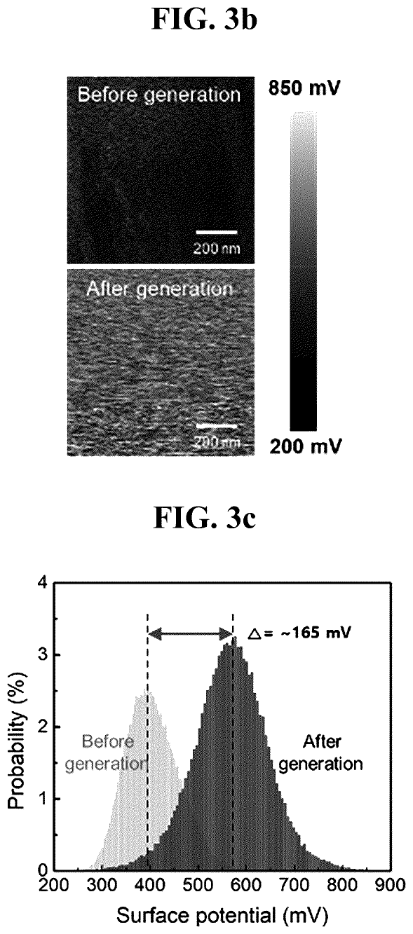

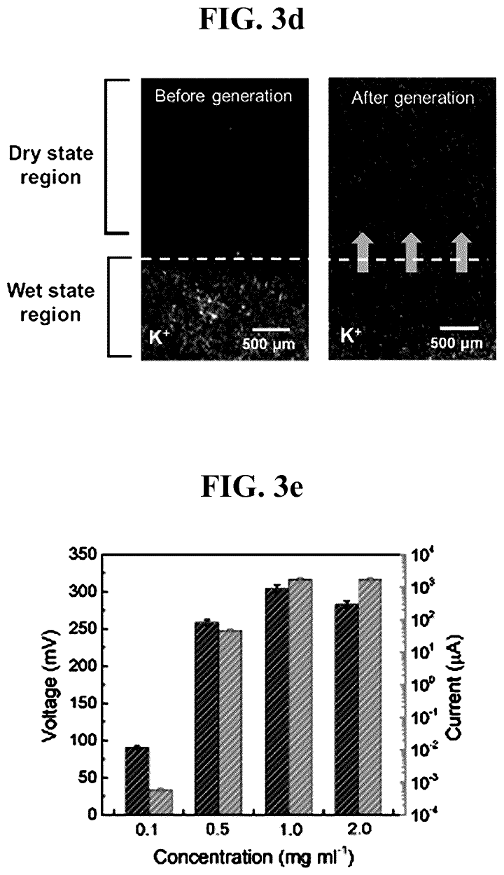

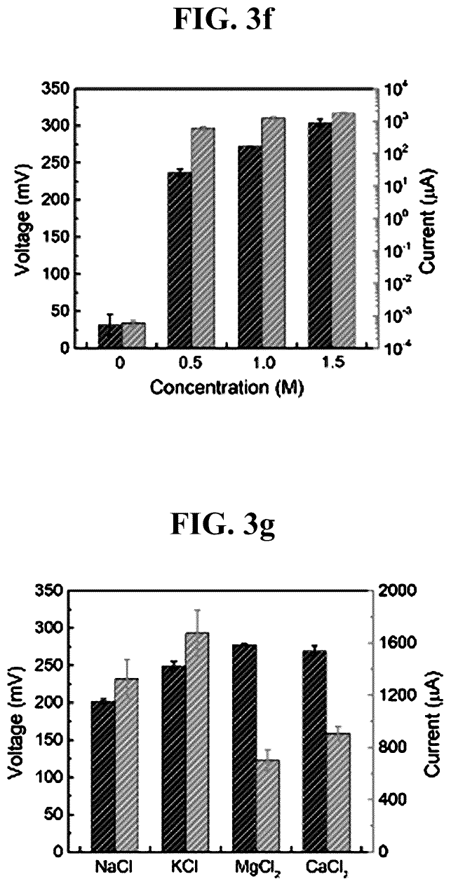

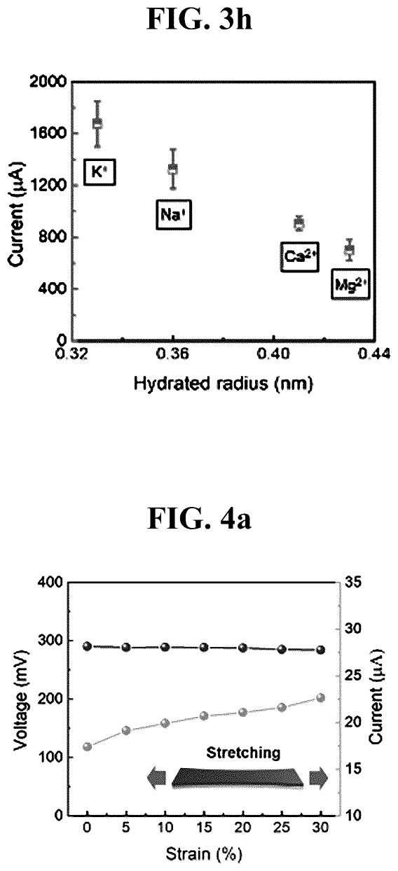

FIGS. 3a-3h show working mechanism of the MEG-MOHF prepared according to one embodiment of the present invention. Specifically, FIG. 3a shows Schematic representation of ion movement across the PVA/MXene layer facilitated by capillary action. FIG. 3b shows Kelvin probe force microscope (KPFM) images and FIG. 3c shows surface potential distributions of top layer of the MEG-MOHF before and after power generation. FIG. 3d show Energy-dispersive X-ray spectroscopy (EDS) mapping of cross-section of MEG-MOHF before and after sustained power generation. FIGS. 3e-3g shows Analysis of power generation performance parameters, including open-circuit voltage (V_{oc}) and short-circuit current (I_{sc}) of MEG-MOHF devices, differing in FIG. 3e MXene concentrations, FIG. 3f KCl concentrations, and FIG. 3g diverse salt ions. FIG. 3h shows Comparison between the measured I_{SC} and the hydrated radius of ions.

The detailed mechanism of electricity generation in an MEG-MOHF is schematically presented in FIG. 3a. The PVA/MXene layers in an MOHF contain various functional groups such as oxygen (—O), hydroxyl (—OH), and fluorine (—F), which render the surface of MOHF hydrophilic with negative zeta potential. When water infiltrates the thinly coated PVA film and moves through the nanosized MXene channels, the MXene channels become negatively charged because of water hydrolysis. The negatively charged MXene nanochannels hinder the movement of the negatively charged ions (OH⁻ and Cl⁻) while allowing the passage of positively charged ions (H₃O⁺ and K⁺) in the organo-ionic hydrogel of the MOHF. This preferential cation transport promotes charge separation, giving rise to an electrical potential difference as well as diffusion current between the bottom and top electrodes. When an external circuit is connected, the internally generated drift current that balances the drift current within the MOHF, decreases. The residual diffusion current is thus balanced via the external circuit, resulting in the generation of a drift current through the external resistor.

A Kelvin probe force microscope (KPFM) validated our proposed mechanism, and the results are presented in FIGS. 3b and 3c. By scanning the surface of the top electrode section of a MEG-MOHF, we observed an increase in the potential, from 398 to 563 mV, after power generation of the MEG-MOHF (FIGS. 3b and 3c). The results implied the preferential accumulation of positive charge carriers through the coated PVA/MXene layers. Furthermore, the energy-dispersive X-ray spectroscopy (EDS) image of a cross-sectional MOHF, as shown in FIG. 3d, also displayed the migration of K⁺ ions along the PVA/MXene layers, from the bottom to the top of the sample. When the volume of the PVA/MXene not coated with the organo-ionic hydrogel increased, the V_{OC} increased slightly, because of the enhanced ionic gradient in the enlarged PVA/MXene. On the other hand, the I_{SC} decreased because of the increased internal resistance, which corroborated our proposed mechanism based on preferential ion separation and transport in the PVA/MXene layers.

We further investigated how the various factors affected the electrical characteristics of the MEG-MOHF. FIG. 3e shows the V_{oc} and I_{sc} of the MEG-MOHF as a function of the MXene concentration, in which both the V_{oc} and I_{sc} were substantially enhanced with the increase in the MXene concentration, reaching a maximum V_{oc} of 305 mV and I_{sc} of ˜1700 μA at a concentration of 1.0 mg ml⁻¹. Above the concentration of 1.0 mg ml⁻¹, however, no significant changes were observed. The improved performance was attributed to the enlarged specific surface area as well as the enhanced electrical conductivity of the MOHF with increased MXene concentration. We also investigated the effect of KCl concentration on the V_{oc} and I_{sc} of MEG-MOHF, and the results are presented in FIG. 3f. The use of an organo-hydrogel without KCl resulted in a V_{oc} and I_{sc} of approximately 31 mV and 0.6 nA, respectively. Substantial enhancements in both V_{oc} and I_{sc} were evident, supporting our claim of salt-associated electricity generation.

We also examined the effects of various desiccant chlorides on the energy-harvesting performance of an MEG-MOHF, and the results are presented in FIGS. 3g and 3h. Four commonly used desiccant chlorides, namely, NaCl, KCl, CaCl₂, and MgCl₂, were examined at equimolar concentrations of 1.0 M. The salts with monovalent ions exhibited higher I_{sc} but lower V_{oc} than that with divalent ions. This behavior could be attributed to the difference in the charge density and mobility of the ions. Divalent ions have a high charge density, contributing to an increased output voltage because of the increased potential difference in an MOHF. In contrast, monovalent ions, with their smaller hydrated radii, experience less hindrance in their movement across the PVA/MXene layers, leading to a higher current generation than that of the divalent ions. Therefore, the K⁺ ion having the smallest hydrated radius exhibits the highest I_{sc}, as shown in FIG. 3h.

### Mechanically Deformable MEG-MOHF

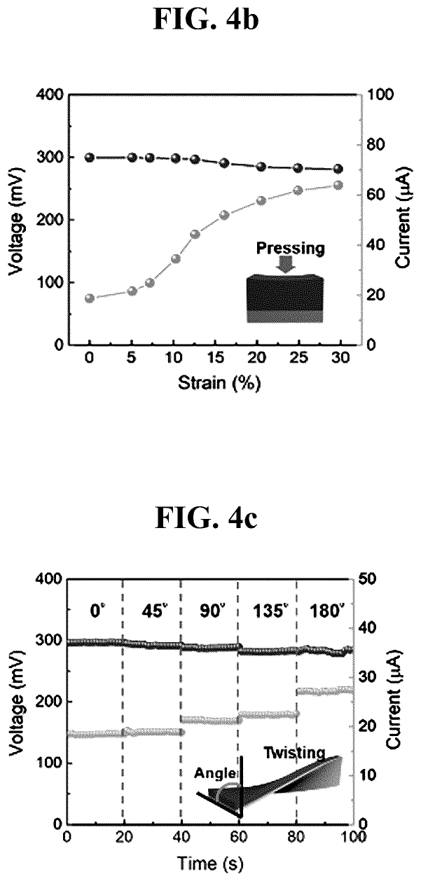

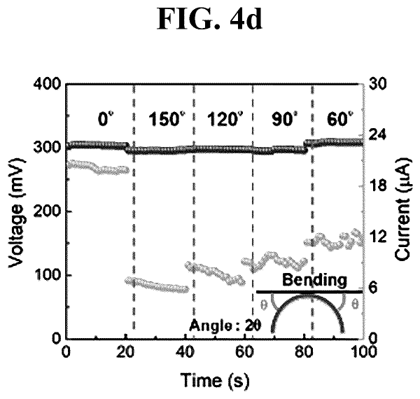

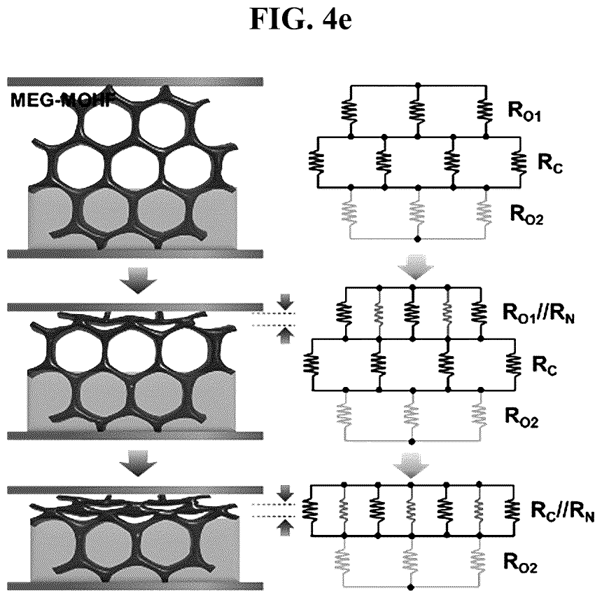

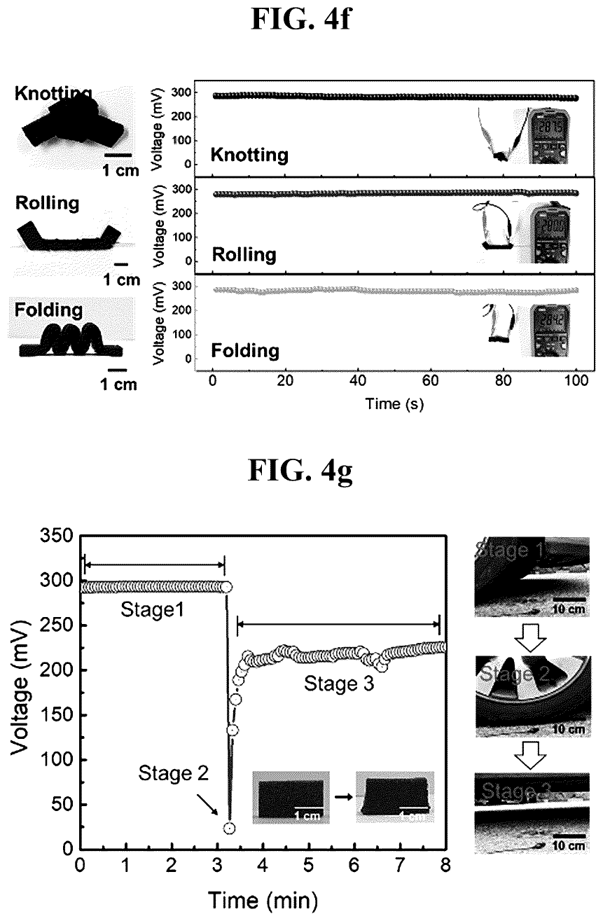

FIGS. 4a-4g show mechanical characteristics of the MEG-MOHF prepared according to one embodiment of the present invention. Specifically, in FIGS. 4a-4d: Variations in open-circuit voltage (V_{oc}) and short-circuit current (I_{sc}) of the MEG-MOHF device under different mechanical manipulations: FIG. 4a stretching, FIG. 4b compression, FIG. 4c twisting, and FIG. 4d bending. FIG. 4e shows Schematic illustrations of resistor network of the MOHF and its corresponding equivalent circuit diagram. FIG. 4f shows Various shape deformations exhibited by the large-scale MEG-MOHF. FIG. 4g shows Measured output voltage of MEG-MOHF under extreme pressure conditions.

The MEG performance of our mechanically deformable MOHFs was explicitly examined, and the results are presented in FIGS. 4a-4g. First, we measured the V_{oc} and I_{sc} under conditions of stretching, pressing, twisting, and bending, and the results are presented in FIGS. 4a, 4b, 4c, and 4d, respectively. For the electrical measurement under stretching, twisting, and bending, an MEG-MOHF with a volume of 40×10×4 mm³ was examined, while the sample subjected to pressing had a volume of 20×20×10 mm³. In all cases, silver-paste-coated PET electrodes were used. Additionally, given that the I_{sc} decreases over time, measurements were conducted after the I_{sc} was sufficiently stabilized, with a value of approximately 20 μA (see FIG. 2b). The results showed that the V_{oc} values were rarely altered even after various deformations, in all samples. The results suggested that the reduced pore size in the MOHF, arising from the compression, stretching, twisting, and bending, rarely altered the ionic gradient within the MOHF.

On the contrary, the I_{sc} increased when the MEG-MOHF was deformed under various mechanical forces. The increase in I_{sc} could be explained with the resistor network model of the conductive framework, as schematically shown in FIG. 4e. The electrical resistance of the composite material (R) could be expressed as the sum of resistances of the outer layers on both sides (R_{O1} and R_{O2}) and the resistance of the central layer (R_{C}). As the layer coated with the organo-ionic hydrogel exhibited a higher compressive modulus than that the uncoated regions, the mechanical deformation was assumed to dominantly occur in the uncoated part. At low strain regimes, the cells in the upper outer layers were flattened first, leading to the formation of conductive connections within those layers, as shown in the middle of FIG. 4e. The electrical resistance in the upper outer layer comprised the initial resistance R_{O1} and resistance R_{N} associated with the new conductive pathways in parallel. Meanwhile, the resistances of the central layer (R_{C}) and another outer layer (R_{O2}) remained unchanged. In this situation, the total resistance could be calculated as R=R_{O1}//R_{N}+R_{C}+R_{O2}. As the strain increased, both the upper outer and central cells flattened, resulting in the formation of many conductive connections. In this case, the total resistance could be expressed as R=R_{C}//R_{N}+R_{O2}. We believe that the formation of conductive paths upon mechanical deformation is responsible for the increase in I_{sc}.

Further experiments were carried out on our MEG-MOHF to assess its energy generation under more severe deformation. The superior flexibility and durability of the MEG-MOHF was showcased by knotting, rolling, and folding a large piece, and the MEG-MOHF concurrently maintained a stable V_{oc} of ˜280 mV, as shown in FIG. 4f. For the extreme pressing test, we drove a car over the MEG-MOHF and monitored the V_{oc} values when the MEG-MOHF was compressed under a moving tire of a commercial car; the result is presented in FIG. 4g. The V_{oc} generated in a stable state (Stage 1 of FIG. 4g) abruptly decreased to ˜25 mV when the car passes over the MEG-MOHF (Stage 2 of FIG. 4g). However, after the car passed, the V_{oc} of the MEG-MOHF recovered to approximately 200 mV, exhibiting the excellent resilience of our MEG-MOHF under mechanical deformation as well as its capability for moisture energy generation.

### TENG Performance of a MOHF

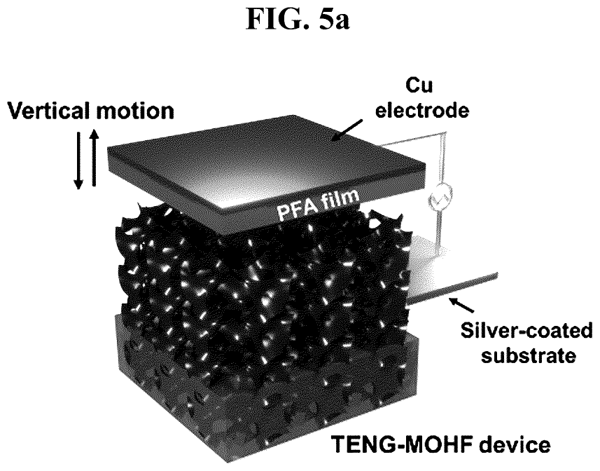

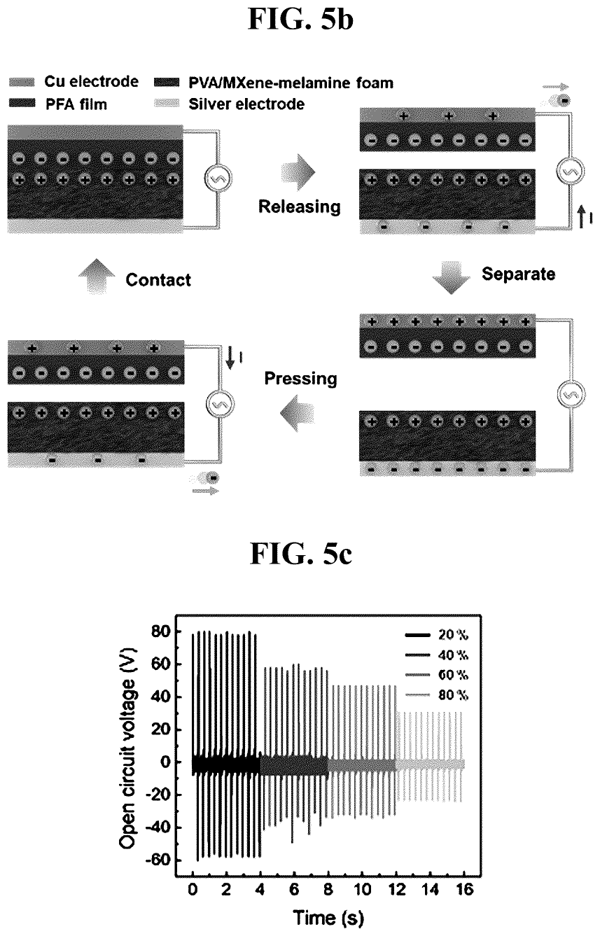

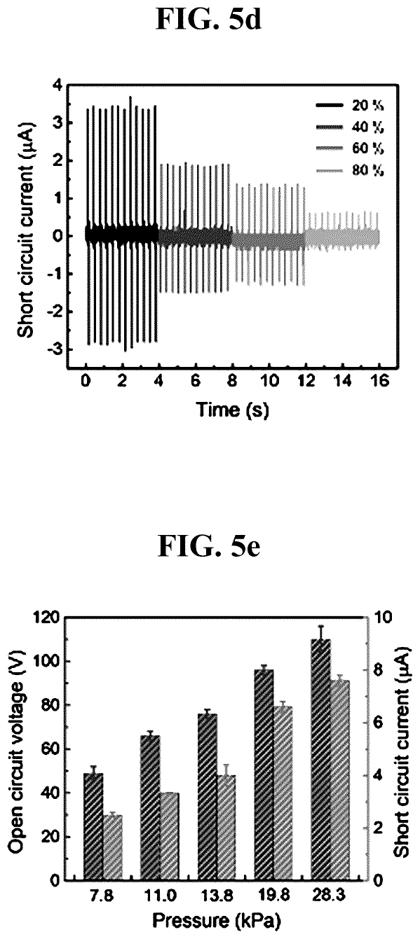

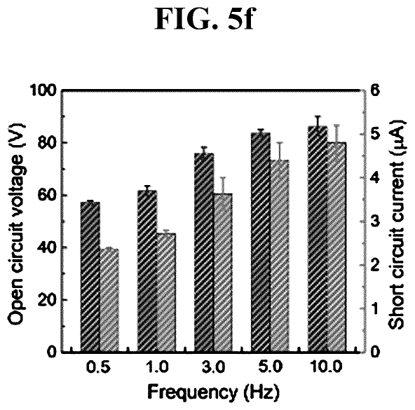

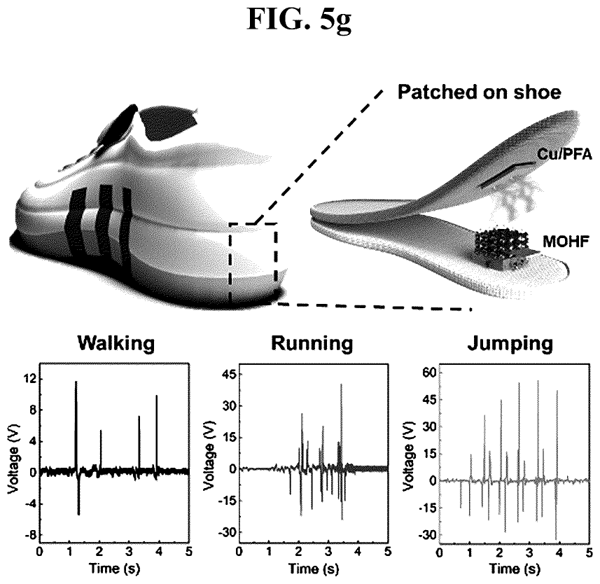

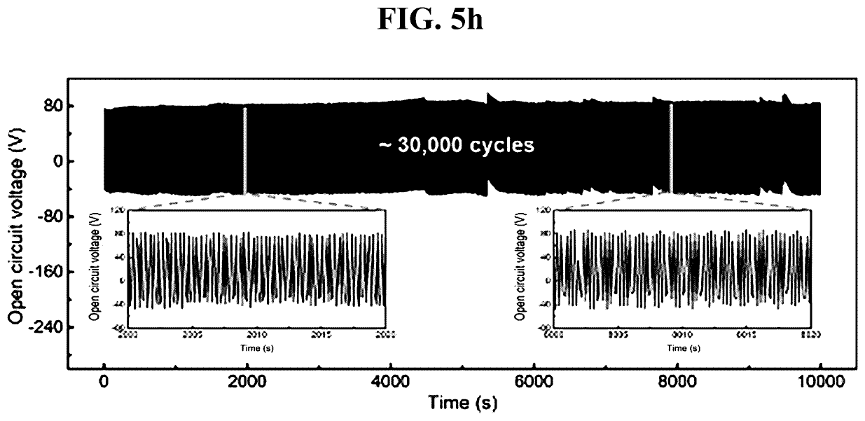

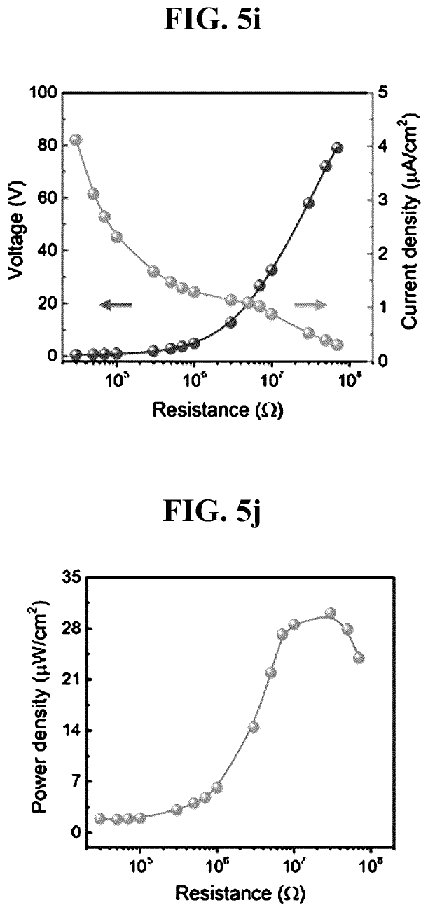

FIGS. 5a-5j show electrical performance of an TENG-MOHF prepared according to one embodiment of the present invention. Specifically, FIG. 5a shows Schematic illustrating the device architecture of the TENG-MOHF. FIG. 5b shows Operational principle of the TENG-MOHF based on contact-separation mode. FIG. 5c V_{oc} and FIG. 5d I_{sc} of TENG-MOHF device, as a function of RH. The V_{oc} and I_{sc} of the TENG-MOHF device with varying FIG. 5e compressive pressures ranging from 7.8 to 28.3 kPa and FIG. 5f vertical motion frequencies from 0.5 to 10.0 Hz. FIG. 5g shows V_{oc} generated from the TENG-MOHF attached to a shoe, during walking, running, and jumping. FIG. 5h shows Stability and durability results of the TENG-MOHF over 30,000 cycles. FIG. 5i shows V_{oc} and J_{sc} of our TENG as a function of external loads from 30 kΩ to 700 MΩ at 20% RH. FIG. 5j shows Power density calculated from V_{oc} and J_{sc} measurements according to FIG. 5i.

Our mechanically resilient MOHF serves as an excellent triboelectric layer in a TENG for harvesting mechanical energy via repetitive vertical contact in addition to the energy harvesting from moisture. A TENG with our MOHF (TENG-MOHF) was implemented by establishing direct contact between a perfluoroalkoxy (PFA) film attached to a Cu electrode and the MOHF incorporating a silver-coated PET substrate, as schematically illustrated in FIG. 5a. The working principle of the TENG-MOHF in the contact-separation mode is schematically shown in FIG. 5b. When the PFA film encounters the MOHF, triboelectrification occurs, generating static charges with opposite signs on the two triboelectric surfaces due to the differences in their work functions. The PFA film acquires a negative charge owing to its high affinity for electrons. Meanwhile, the surface of MOHF becomes positively charged, thereby inducing a potential difference between the two electrodes. As the PFA film begins to separate from the MOHF, electrons flow from the Cu electrode to the silver electrode via an external circuit, for maintaining charge equilibrium. This flow of electrons generates an electrical output current and continues until all the negative charges accumulated on the surface of the PFA are completely compensated. When the PFA film subsequently approaches the MOHF again, the direction of electron movement reverses from the silver electrode back to the Cu electrode, for maintaining the charge balance, thereby producing an electrical output signal of the opposite polarity (FIG. 5b).

The triboelectric output voltage and current of a TENG-MOHF were examined as functions of the relative humidity, and the results are presented in FIGS. 5c and 5d, respectively. The humidity-dependent triboelectric performance of our device is of importance to develop a complementary energy generator integrating MEG and TENG with our MOHF (complementary MEG-TENG-MOHF), as will be shown later. The surface area of the PFA film was adjusted to 2×2 cm² to match the top surface area of the MOHF, prior to the measurement. At 20% RH, the TENG-MOHF exhibited a maximum V_{oc} of 80 V and I_{sc} of 3.5 μA. These values surpassed the electrical performances of a TENG with either the bare melamine foam or the MXene film coated on a melamine foam. However, a gradual decrease in both V_{oc} and I_{sc} was observed with the RH increase. A V_{oc} of 30 V and I_{sc} of 0.65 μA were harvested at 80% RH. Because moisture in the air could induce a current between the charged surfaces, the static electricity arising from the TENG-MOHF was readily dispersed at high humidities, leading to a decreased power output, consistent with the previous results. The results anticipate that a complementary MEG-TENG-MOHF could allow the generation of high power at low humidity conditions under which most of the MEGs exhibit low harvesting performance owing to the lack of moisture.

Because of the excellent mechanical flexibility and resilience of our MOHF, a TENG-MOHF can harvest energy under various compression conditions, and the results are presented in FIG. 5e. The V_{oc} of the TENG-MOHF increased from 50 to 110 V and the I_{sc} increased from 2.5 to 7.6 μA as the compression pressure increased from 7.8 to 28.3 kPa. The various pressures were applied to result in the compression of the device from 10 to 52%. Furthermore, the TENG-MOHF exhibited a substantial increase in both V_{oc} and I_{sc} with the increase in the operation frequency from 0.5 to 10 Hz, as shown in FIG. 5f. The enhancement of the device performance at high frequencies was due to the low dispersion of the induced charges in the PFA film and MOHF. FIG. 5g demonstrates the mechanical robustness of our MOHF, which allows us to harvest the triboelectric energy of a TENG-MOHF patched on a shoe, arising from various human motions such as walking, jumping, and running. The mechanical durability of the TENG-MOHF was further confirmed by its reliable TENG performance, even after more than 30,000 consecutive triboelectric contacts, as shown in FIG. 5h. The power densities of the TENG-MOHF were determined by measuring the V_{oc} and J_{sc} across various external loads ranging from 30 kΩ to 70 MΩ, as depicted in FIG. 5i. These results show that a maximum power density of approximately 30.1 μW cm⁻² can be achieved at 30 MΩ (FIG. 5j).

### Deformable Complementary MEG-TENG-MOHF

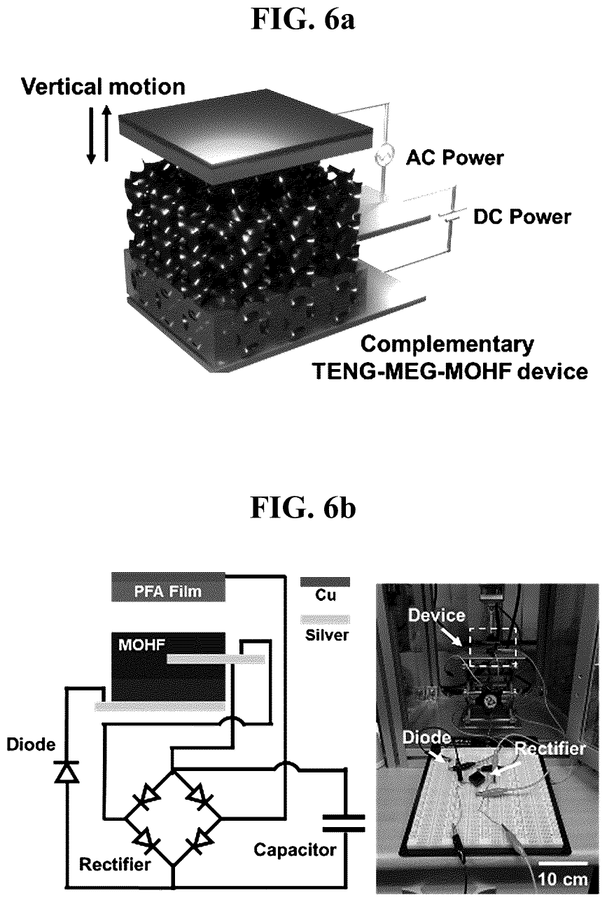

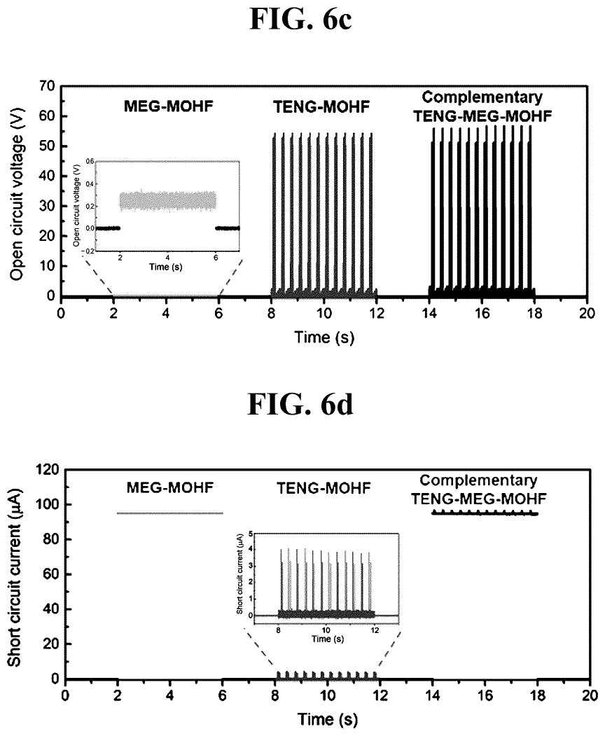

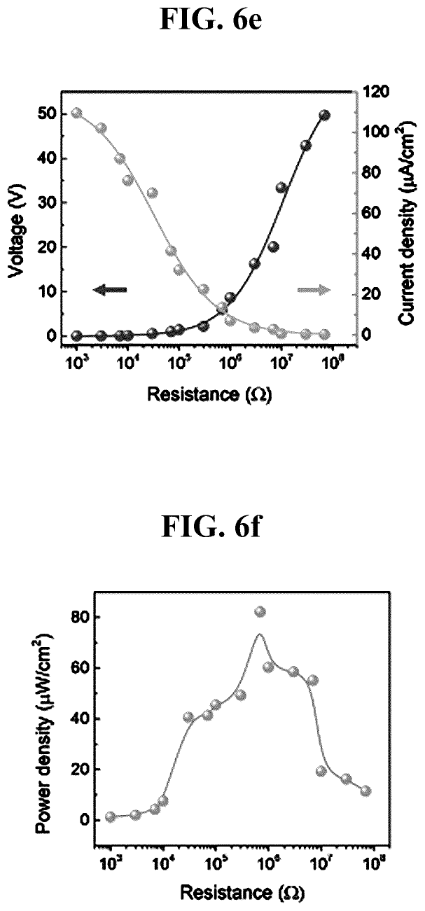

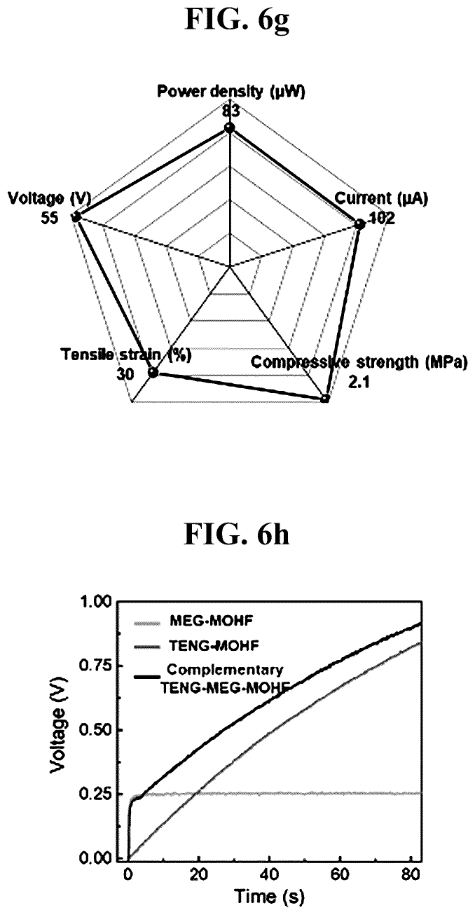

FIGS. 6a-6h show electrical performance of a complementary MEG-TENG-MOHF prepared according to one embodiment of the present invention. Specifically, FIG. 6a shows Schematic illustrating the device architecture of the complementary MEG-TENG-MOHF. FIG. 6b shows Circuit diagram and photograph of the complementary MEG-TENG-MOHF used for powering the load device. Comparison of FIG. 6c V_{oc} and FIG. 6d I_{sc} for the MEG-MOHF, TENG-MOHF, and complementary MEG-TENG-MOHF. FIG. 6e shows Dependence of the V_{oc} and J_{sc} of complementary MEG-TENG-MOHF on the load resistances at 20% RH. FIG. 5f shows Power density calculated from the results in FIG. 6e. FIG. 6g shows Radial plot of the voltage, current, power density, tensile strength, and compressive strength for our complementary MEG-TENG-MOHF. FIG. 6h shows Capacitor charging characteristics of each energy generator using a 4.7 μF capacitor.

By utilizing the capability of our MOHF for harvesting energy from ambient moisture as well as tribo-contact force, we developed a complementary MEG-TENG-MOHF where both MEG and TENG were integrated in a single device platform with a shared MOHF, as schematically illustrated in FIG. 6a. The silver-coated PET electrode was inserted into the middle of the PVA/MXene-melamine foam within the MOHF. The inserted electrode served as a mutual electrode, functioning as the top electrode for the MEG-MOHF and bottom electrode for the TENG-MOHF. The Cu/PFA tribo-contact electrode (the top electrode of the TENG-MOHF) and the inserted electrode (the bottom electrode of the TENG-MOHF) were connected to two terminals of a bridge rectifier to convert alternating current (AC) into direct current (DC), as schematically shown in FIG. 6b. The remaining two terminals of the bridge rectifier were connected to the top and bottom electrodes of the MEG-MOHF (FIG. 6b). Furthermore, a diode was connected to the bottom electrode of the MEG-MOHF to inhibit the electron leakage during energy generation. A complementary MEG-TENG-MOHF was successfully fabricated with the designed circuits, as shown in the photograph in FIG. 6b.

The electrical performance of our complementary MEG-TENG-MOHF was evaluated at an RH of 20%, and the results are shown in FIGS. 6c and 6d. The complementary MEG-TENG-MOHF exhibited a V_{oc} and I_{sc} of approximately 55 V and 100 μA, respectively, accompanied by intermittent peaks at regular intervals. As noted from the electrical performances of the MEG-MOHF and TENG-MOHF obtained at the same time for comparison, the high V_{oc} and I_{sc} in the complementary MEG-TENG-MOHF could be ascribed to the high output voltage of the TENG-MOHF and high current of the MEG-MOHF, respectively. Bright light was emitted from two commercial LEDs connected in series with our complementary MEG-TENG-MOHF, while no or somewhat weak light emission was observed from the MEG-MOHF and TENG-MOHF. The power densities of the complementary MEG-TENG-MOHF were evaluated from the load-resistance-dependent output voltages and current densities of the device, and the results are presented in FIGS. 6g and 6f. Across a wide range of load resistances from 1 kΩ to 70 MΩ, the average power density of our complementary MEG-TENG-MOHF was determined to be approximately 33.6 μW cm⁻². The maximum power density achieved was approximately 83 μW cm⁻² at 700 kΩ, as shown in FIG. 6f.

It is worth noting that the maximum power density and mechanical performance of our complementary device is superior to the performances of the recent MEGs (FIG. 6g). The power density is comparable with that obtained from solar and other MEG hybrid devices. Moreover, our complementary MEG-TENG-MOHF with excellent mechanical flexibility and resilience is suitable for applications associated with large mechanical force, as will be shown later.

To further explore the synergy of energy-storage capabilities of MEG-MOHF and TENG in our complementary MEG-TENG-MOHF device, we performed charging experiments with a 4.7 μF capacitor, and the results are shown in FIG. 6h. In the capacitor charging curve of the complementary device, the initial voltage of the capacitor rapidly reached approximately 0.25 V within 1-2 s. Subsequently, the voltage increased almost linearly over time, reaching approximately 0.9 V after 80 s. The charging curve of the MEG-MOHF showed a rapid increase in the charge voltage to 0.25 V in a few seconds. The charging from the TENG-MOHF occurred almost linearly with time, reaching the charging voltage of approximately 0.8 V after 80 s (FIG. 6h). The high capacitor-charging performance of the complementary MEG-TENG-MOHF was explained by the rapid initial voltage increase of the capacitor, a result of the DC characteristics of the MEG-MOHF, followed by the subsequent charging of the device, facilitated by the TENG-MOHF part. The high charging performance of our complementary harvester was facilitated in capacitors with higher capacities. In addition, the reliable charging and discharging characteristics of a complementary MEG-TENG-MOHF were confirmed.

### Self-Powered Emergency-Exit Guidance System With Deformable Complementary MEG-TENG-MOHF

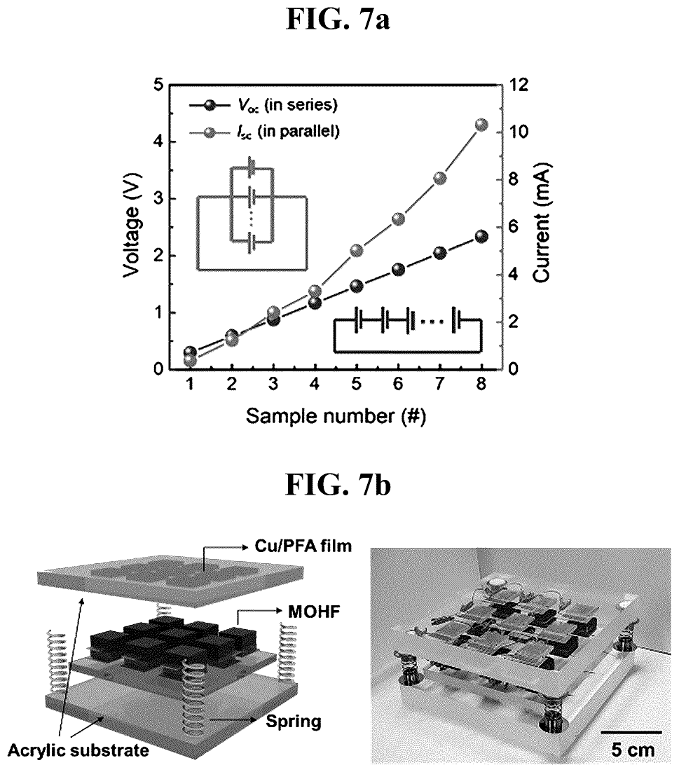

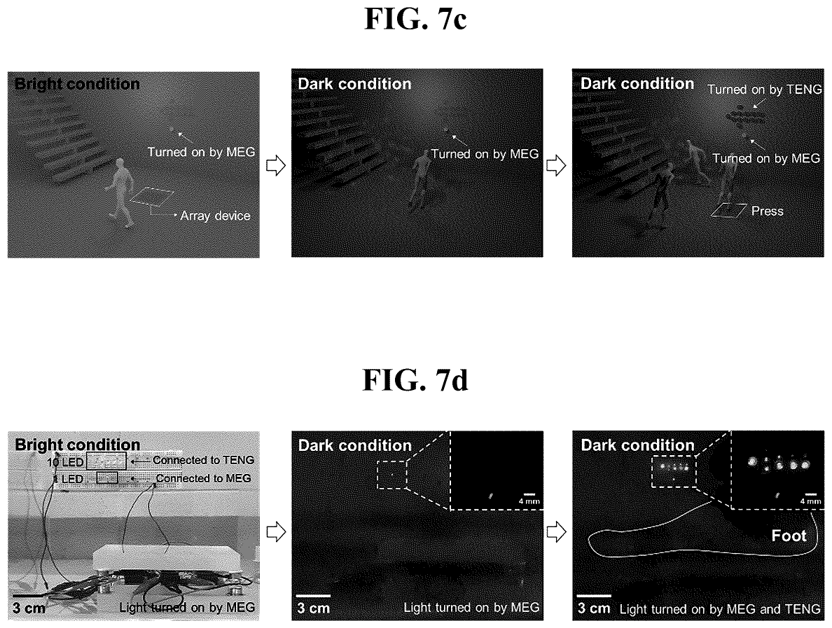

FIGS. 7a-7d show how to prepare and utilize an emergency exit guidance system according to one embodiment of the present invention. Specifically, FIG. 7a shows Scaling up of V_{oc} and I_{sc} by connecting multiple MEG-MOHFs in series and in parallel. FIG. 7b shows Schematic and photograph of 3×3 arrays of complementary MEG-TENG-MOHFs. Multiple MOHFs are connected in series, while PFA films are connected in parallel. FIG. 7c shows Schematic illustration and FIG. 7d shows experimental results demonstrating the utilization of arrays in complementary MEG-TENG-MOHFs for an emergency exit guidance system.

For practical applications suitable with our deformable complementary MEG-TENG-MOHF, it is necessary to scale up the power output of the system. FIG. 7a shows the connection of multiple MEG-TENG-MOHFs (up to eight devices) in series or parallel to amplify the output voltage and current, respectively, in MEG mode, thereby enabling the operation of diverse commercial electronic products. To capitalize on the mechanical resilience of our complementary MEG-TENG-MOHF, which can withstand human weight, we propose a novel self-powered emergency-exit guidance system, which can visually guide people to an emergency exit when needed. 3×3 arrays of complementary MEG-TENG-MOHFs were fabricated on an acrylate substrate with Cu/PFA films separated from the arrays of MOHFs with four springs, as shown in the schematic and photograph in FIG. 7b. In the array system, nine MEG-MOHF units were connected in series, producing continuous moisture-driven DC output power, while the TENG-MOHF units were connected in parallel, producing high-power AC output from the transient human walking motion.

FIG. 7c demonstrates the scenario of the implementation of our self-powered emergency-exit guidance system. In normal conditions, an LED sign near the exit is always ON, driven by the continuous DC power from the arrays of MEG-MOHFs; however, this sign is not sufficiently bright owing to the relatively low output power of the MEG. In emergency situations such as fires, where indoor lighting is limited, the MEG-driven light can serve as an initial guide toward the emergency exit, allowing nearby individuals to follow the light and escape. When the individuals follow the sign light and step on our array system located near the exit while evacuating, the arrays of TENG-MOHFs begin to generate additional output power, from the repetitive contacts of the Cu/PFA plates on MOHFs, giving rise to additional visual guidance toward the exit, as schematically shown in FIG. 7c. When more individuals move toward the exit, more power is generated from the array system with more vivid exit guidance, allowing for development of a self-powered and self-perpetuating system for effective evacuation.

A proof-of-the-concept of the self-powered emergency exit guidance system was developed using arrays of our complementary MEG-TENG-MOHFs, and the results are presented in FIG. 7d. A single red LED is connected to the circuit of arrays of MEG-MOHF units while 10 blue LEDs arranged in the shape of an arrow are connected to the circuit of arrays of the TENG-MOHF units. Under bright conditions, the red light emitted by the MEG-MOHF array is hardly visible, as shown in the left image of FIG. 7d; however, it becomes easily noticeable in the simulated emergency with the surrounding lights turned off. Subsequently, when the array system is repetitively stepped on by foot, the arrow shaped blue LEDs are turned on by the output power produced by the arrays of TENG-MOHFs, significantly enhancing the perception of lights, as shown in the right photograph in FIG. 7d.

### Experimental Example

In accordance with one embodiment of the present invention, actual experiments are described below.

### (1) Materials

The melamine foam used was a commercially available product in Korea. Acrylamide (≥99%), N,N′-methylenebis (acrylamide) (MBAA, 98%), ammonium persulfate (APS, 98%), glycerol (≥99.5%), KCl, NaCl, CaCl₂, MgCl₂, and poly(vinyl alcohol) (PVA, Mw=30,000˜70,000) were purchased from Sigma-Aldrich, Korea. The MXene suspension (10 mg ml⁻¹) was purchased from XinXi Technology Co., Ltd. (Foshan, China). Deionized (DI) water (18.3 MΩ·cm) was prepared using a reverse-osmosis water system (Human Corporation, Korea). The 25 μm thick perfluoroalkoxy alkane (PFA) was purchased from Alphaflon, Korea.

### (2) Preparation of Melamine-Foam Coated With MXene and PVA (PVA/MXene-Melamine Foam)

The preparation of the PVA/MXene-melamine foam involved a dip-coating method. Initially, the melamine foam was cut into cubes of dimension 20×20×10 mm³. The foam was then immersed in MXene solution diluted in DI water (1.0 mg ml⁻¹) for 10 min and was squeezed several times to ensure that the solution permeated well into the foam. The wet melamine foam was dried overnight at 60° C. in an oven. Subsequently, the dried sample was dipped in a PVA solution (0.1 wt %) for 10 min. The final product, PVA/MXene-melamine foam, was obtained after completely drying overnight in an oven at 60° C.

### (3) Preparation of MXene/Organo-Ionic Hydrogel Foam (MOHF)

Acrylamide monomers (1.54 g), MBAA cross-linker (0.006 g), and APS initiator (0.016 g) were dissolved in a solvent containing a mixture of 10 ml glycerol and DI water in a 3:2 volume ratio. The solution was stirred magnetically for 30 min, and KCl was added to the solution to obtain various concentrations. Then, 1 ml of the solution was poured into a custom-designed mold, and the prepared PVA/MXene-melamine foam was placed on top to allow infusion of the organo-ionic hydrogel solution into the lower part through capillary action. Finally, the solution was thermally treated on a hot plate at 85° C. for 10 minutes until the viscous solution gradually polymerized, forming the MOHF.

### (4) Characterization & Measurement

The surface morphology and crystallinity of the melamine foam and PVA/MXene-melamine foam were examined using field-emission scanning electron microscopy (FE-SEM) at an acceleration voltage of 10.0 kV (JEOL, JSM-7001F) and high-resolution X-ray diffraction (HR-XRD, Rigaku, SmartLab). The coated layer of MXene and PVA on the melamine foam was confirmed through transmission electron microscopy (TEM, JEOL, JEM-ARM 200F). The chemical compositions of the PVA/MXene-melamine foam and its components were studied using X-ray photoelectron spectroscopy (XPS, Thermo U. K., K-alpha). The zeta potential of the PVA/MXene-melamine foam was measured using a zeta potential analyzer (Otsuka Electronics, ELS-1000ZS). Numerical simulations of the concentration distribution of K⁺ over time in the MOHF were conducted using finite element analysis (FEA) software (COMSOL, Inc., COMSOL Multiphysics 5.6). The mechanical properties were evaluated on a universal testing machine (UTM, Instron, Instron 3366) with a 50 N load cell. Strip-shaped samples sized 40×10×4 mm³ were axially stretched at a loading rate of 10 mm min⁻¹ with a gauge length of 20 mm between the clamps. Additionally, a sample of size 20×20×10 mm³ was vertically compressed at a loading rate of 10 mm min⁻¹ for compressive testing. The V_{oc} and I_{sc} of the MEG-MOHF, TENG-MOHF, and complementary MEG-TENG-MOHF were obtained using a commercial multimeter, Keithley 6514 electrometer, and Keithley 6485 picoammeter. The RH within a controlled environment was maintained in the homemade acrylic humidity chamber. To establish a controlled temperature range below freezing (−20° C.) to 60° C., a refrigerator and hot plate were utilized in the experimental setup. The transport of ions and changes in the surface potential following the generation from the MEG-MOHF were analyzed using energy-dispersive spectrometry (EDS, JEOL, JSM-7610F-Plus) and Kelvin probe force microscope (KPFM) characterizations (Park Systems, NX-10).

1. An organo-ionic hydrogel foam, comprising:
a MXene foam comprising MXene and having a three-dimensional framework structure; and
an organo-ionic hydrogel coating a portion of the MXene foam,
wherein a dry-state region not coated by the organo-ionic hydrogel is positioned over a wet-state region coated by the organo-ionic hydrogel.

2. The organo-ionic hydrogel foam according to claim 1,
wherein the MXene foam is a three-dimensional melamine foam with two-dimensional MXene flakes attached thereto.

3. The organo-ionic hydrogel foam according to claim 1,
wherein the organo-ionic hydrogel is based on polyacrylamide (PAM), containing glycerol and an ionic salt.

4. A method of manufacturning an organo-ionic hydrogel foam, comprising:
preparing a MXene foam comprising MXene and having a three-dimensional framework structure; and
coating a portion of the MXene foam with an organo-ionic hydrogel.

5. The method of manufacturning an organo-ionic hydrogel foam according to claim 4,
wherein the preparing a MXene foam comprises coating a surface of a melamine foam with MXene flakes.

6. The method of manufacturning an organo-ionic hydrogel foam according to claim 4,
wherein the coating a portion of the MXene foam comprises partially coating the MXene foam with the organo-ionic hydrogel based on polyacrylamide (PAM) and containing glycerol and an ionic salt.

7. A moisture-induced electric generator, comprising:
the organo-ionic hydrogel foam according to claim 1;
a first conductive substrate disposed on a lower portion of the organo-ionic hydrogel foam; and
a second conductive substrate inserted into the dry-state region of the organo-ionic hydrogel foam.

8. A triboelectric generator, comprising:
the organo-ionic hydrogel foam according to claim 1;
a third conductive substrate disposed on a upper portion of the organo-ionic hydrogel foam; and
a fourth conductive substrate inserted into the dry-state region of the organo-ionic hydrogel foam.

9. A moisture-induced electric and triboelectric generator, comprising:
the organo-ionic hydrogel foam according to claim 1;
a fifth conductive substrate disposed on a lower portion of the organo-ionic hydrogel foam;
a sixth conductive substrate disposed on a upper portion of the organo-ionic hydrogel foam; and
a seventh conductive substrate inserted into the dry-state region of the organo-ionic hydrogel foam,
wherein, the fifth conductive substrate, the organo-ionic hydrogel foam, and the seventh conductive substrate generate direct current (DC) power by moisture-induced electric generation, and
wherein, the sixth conductive substrate, the organo-ionic hydrogel foam, and the seventh conductive substrate generate alternating current (AC) power by triboelectric generation.

10. An emergency-exit guidance system using the moisture-induced electric and triboelectric generator according to claim 9,
wherein the direct current (DC) power by moisture-induced electric generation is always on, and
wherein the alternating current (AC) power by triboelectric generation is generated by the steps of individuals evacuating in emergency situations.
